(19) United States
(12) Patent Application Publication
(10) Pub. No.: US 2012/0304048 A1
(43) Pub. Date: Nov. 29, 2012

(54) INFORMATION PROCESSING APPARATUS, INFORMATION PROCESSING METHOD, PROGRAM, SERVER AND INFORMATION PROCESSING SYSTEM

(75) Inventors: Yuya Aoki, Tokyo (JP); Mitsuru Nishibe, Tokyo (JP); Takahiro Okayama, Tokyo (JP); Shunichi Kasahara, Kanagawa (JP)

(73) Assignee: SONY CORPORATION, Tokyo (JP)

(21) Appl. No.: 13/469,537

(22) Filed: May 11, 2012

(30) Foreign Application Priority Data
May 19, 2011 (JP) 2011-112343

(51) Int. Cl. G06F 17/00

(52) U.S. Cl. 715/234

(57) ABSTRACT

There is provided an information processing apparatus including an obtaining unit that obtains operation vector information that is generated based on log information on an operation performed on one web page screen by a user of another apparatus, and that indicates a vector of the operation, from a server; and an operation control unit that controls an operation to be automatically performed on the one web page screen displayed on a display unit, depending on the operation vector information obtained by the obtaining unit.

### BACKGROUND

The present disclosure relates to an information processing apparatus, an information processing method, a program, a server and an information processing system.

In recent years, with popularization of the Internet and improvement in hardware technology, many users are using information terminal apparatuses, such as personal computers and cellular phones. Such information terminal apparatuses include web browsers for browsing web pages, and provide increasing opportunities to use the web browsers to view the web pages (see Japanese Patent Laid-Open No. 2009-75908).

### SUMMARY

Incidentally, the users do not typically browse the same web page, and may search for information on web pages that the users do not usually browse. During browsing such web pages, the users may not be able to understand where desired information is arranged on web page screens, at first glance, and may take time to browse the desired information.

Accordingly, there is a need for a method of enabling a user to easily browse desired information from a web page, and even from a web page that the user does not usually browse.

According to an embodiment of the present disclosure, there is provided an information processing apparatus including an obtaining unit that obtains operation vector information that is generated based on log information on an operation performed on one web page screen by a user of another apparatus, and that indicates a vector of the operation, from a server; and an operation control unit that controls an operation to be automatically performed on the one web page screen displayed on a display unit, depending on the operation vector information obtained by the obtaining unit.

Moreover, according to another embodiment of the present disclosure, there is provided a server including an obtaining unit that obtains log information on an operation performed on one web page screen by a user of one apparatus, from the one apparatus; a generation unit that generates operation vector information indicating a vector of the operation, based on the operation log information obtained by the obtaining unit; and a notification unit that notifies another apparatus that is caused to display the one web page screen, of the operation vector information generated by the generation unit.

In addition, according to yet another embodiment of the present disclosure, there is provided an information processing system including an information processing apparatus; and a server communicable with the information processing apparatus and another apparatus, wherein the server includes a first obtaining unit that obtains log information on an operation performed on one web page screen by a user of the other apparatus, from the other apparatus; a generation unit that generates operation vector information indicating a vector of the operation, based on the operation log information obtained by the first obtaining unit; and a notification unit that notifies the information processing apparatus that is caused to display the one web page screen, of the operation vector information generated by the generation unit, and wherein the information processing apparatus includes a second obtaining unit that obtains the operation vector information generated by the generation unit, via the notification unit from the server; and an operation control unit that controls an operation to be automatically performed on the one web page screen displayed on a display unit, depending on the operation vector information obtained by the second obtaining unit.

According to the embodiments of the present disclosure described above, a user can easily browse desired information from a web page, and even from a web page that the user does not usually browse.

### BRIEF DESCRIPTION OF THE DRAWINGS

FIG. 1 is a diagram illustrating a configuration of an information processing system;

FIG. 2 is a diagram illustrating a detailed configuration of a first user terminal;

FIG. 3 is a diagram illustrating a web page displayed on a display unit;

FIG. 4 is a diagram illustrating a detailed configuration of a server;

FIG. 5 is a schematic diagram for describing a method of generating an operation vector;

FIG. 6 is a schematic diagram for describing an operation field generated by a generation unit;

FIG. 7 is a diagram illustrating a detailed configuration of a second user terminal;

FIG. 8 is a diagram for describing an automatic operation of a cursor on a web page screen;

FIG. 9 is a diagram for describing a displayed movement of a pseudo-cursor;

FIG. 10 is a flowchart illustrating a process of generating the operation field by the server;

FIG. 11 is a flowchart illustrating a process of obtaining a frequency of updating the operation field;

FIG. 12 is a flowchart illustrating a process of generating the operation vector of the cursor; and

FIG. 13 is a flowchart illustrating an automatic operation process performed on the web page screen by the second user terminal.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be provided in the following order.

1. Configuration of Information Processing System

2. Detailed Configuration of First User Terminal

3. Detailed Configuration of Server

4. Detailed Configuration of Second User Terminal

5. Operations of Information Processing System
5-1. Process of Generating Operation Field
5-2. Automatic Operation Process on Web Page Screen

6. CONCLUSION

### 1. CONFIGURATION OF INFORMATION PROCESSING SYSTEM

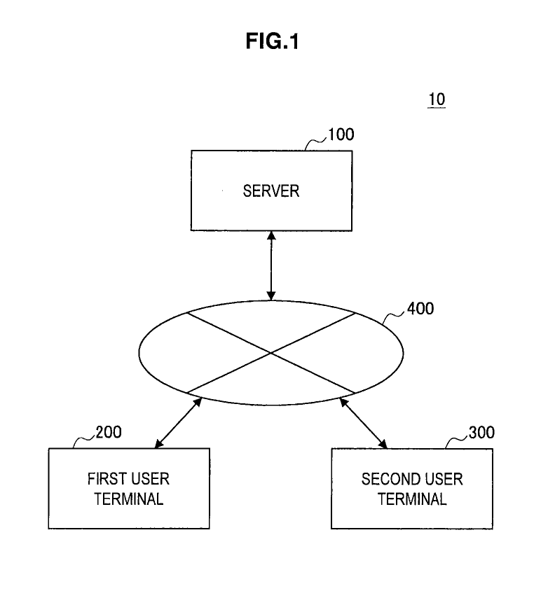

With reference to FIG. 1, a configuration of an information processing system 10 according to the present embodiment will be described. FIG. 1 is a diagram illustrating the configuration of the information processing system 10.

As illustrated in FIG. 1, the information processing system 10 includes a server 100, a first user terminal 200, a second user terminal 300 and a network 400. Each of the first user terminal 200 and the second user terminal 300 can communicate with the server 100 via the network 400. Note that while FIG. 1 illustrates two user terminals, the number of the user terminals is not limited and may be three or more.

The first user terminal 200 is a terminal, such as a personal computer, used by a first user. The first user terminal 200 obtains a web page from an apparatus (for example, a web server) connected to the network 400. The first user terminal 200 causes a display unit to display the obtained web page in a web browser, and accepts an operation performed on one web page screen by the first user. The first user terminal 200 transmits log information on the operation performed on one web page screen by the first user, to the server 100. Note that a detailed configuration of the first user terminal 200 will be described later.

The web page, for example, may be a document described in an HTML (HyperText Markup Language) format, or may be text data. Moreover, web pages are connected to one another through links, and transition among the web pages is performed with click operations and the like.

The server 100 manages information related to the web pages displayed by the first user terminal 200 and the second user terminal 300. The server 100 obtains the log information on the operation performed on one web page screen by the user of the first user terminal 200, from the first user terminal 200, as will be described in detail later. The server 100 generates operation vector information indicating a vector of the operation, based on the obtained operation log information. The server 100 notifies the second user terminal 300 that is caused to display one web page screen, of the generated operation vector information. Note that a detailed configuration of the server 100 will be described later.

The second user terminal 300 is a terminal, such as a personal computer, used by a second user different from the first user. The second user terminal 300 obtains the operation vector information generated by the server 100, from the server 100, as will be described in detail later. The second user terminal 300 controls an operation to be automatically performed on one web page screen displayed on a display unit, depending on the obtained operation vector information. Note that a detailed configuration of the second user terminal 300 will be described later.

### 2. DETAILED CONFIGURATION OF FIRST USER TERMINAL

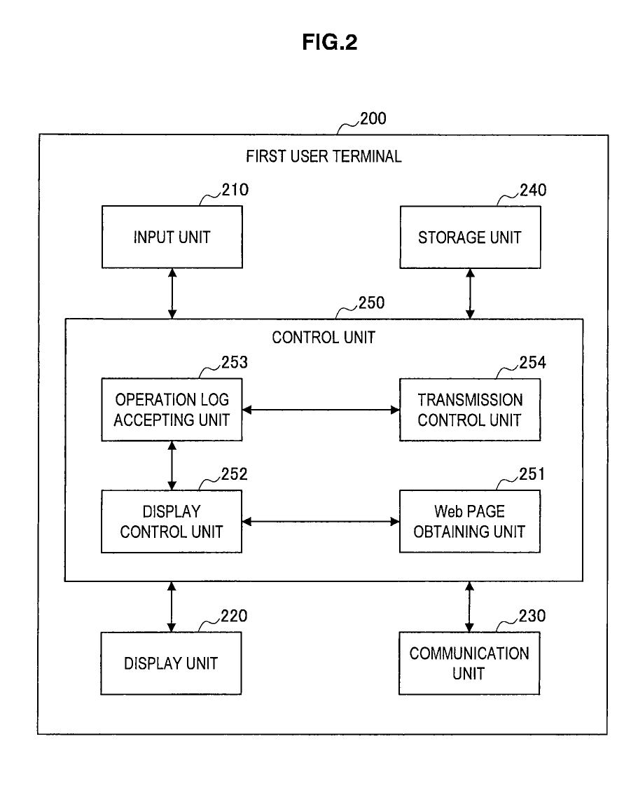

With reference to FIG. 2, the detailed configuration of the first user terminal 200 will be described. FIG. 2 is a diagram illustrating the detailed configuration of the first user terminal 200. As illustrated in FIG. 2, the first user terminal 200 includes an input unit 210, a display unit 220, a communication unit 230, a storage unit 240 and a control unit 250.

The input unit 210 has a function of accepting input of operation information from the first user. For example, the input unit 210 accepts input while the first user operates a mouse. The input unit 210 outputs the accepted input of the operation information from the first user, to the control unit 250. Moreover, the input unit 210 accepts attribute information on the first user, which has been inputted by the first user, for example, information on the first user's sex, date of birth, hometown, web environment, frequency of web surfing. The input unit 210, for example, includes an input device, such as a mouse, a keyboard or a touch panel.

The display unit 220 has a function of displaying various kinds of information based on control by the control unit 250. The display unit 220 displays a screen of the web page obtained from the web server. The display unit 220, for example, includes a display device, such as a liquid crystal display.

The communication unit 230 has a function of communicating with the server 100 based on the control by the control unit 250. The communication unit 230, for example, includes a communication device, and may function as a transmission unit and a reception unit. The communication unit 230, for example, receives the web page from the web server.

The storage unit 240 has a function of storing various kinds of information to be used by the control unit 250. The storage unit 240, for example, includes a storage device, such as a magnetic storage device.

The control unit 250 has a function of controlling all the operations of the first user terminal 200, and for example, can control the operations of the first user terminal 200 based on the operation information outputted from the input unit 210, information received by the communication unit 230. The control unit 250, for example, includes a CPU, a ROM and a RAM. As illustrated in FIG. 2, the control unit 250 includes a web page obtaining unit 251, a display control unit 252, an operation log accepting unit 253, and a transmission control unit 254.

The web page obtaining unit 251 obtains the web page from the apparatus (for example, the web server) connected to the network 400, via the communication unit 230. For example, the web page obtaining unit 251 obtains a desired web page inputted (selected) through the input unit 210 by the first user, from the web server.

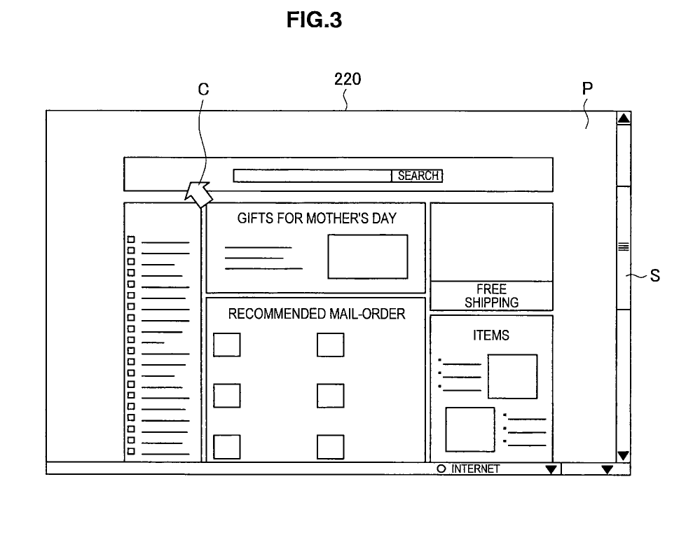

The display control unit 252 controls the display unit 220 to display the obtained web page in the web browser. As illustrated in FIG. 3, the case where one web page P is displayed on the display unit 220 will be described herein by way of example.

FIG. 3 is a diagram illustrating the web page P displayed on the display unit 220. The first user moves a cursor C on the web page P illustrated in FIG. 3 and performs the click operation on the web page. Moreover, a scroll bar S is displayed on the web page P. A screen of the web page P vertically moves while the first user vertically moves the scroll bar S with the cursor C.

The operation log accepting unit 253 accepts the operation performed on the web page P screen by the first user. For example, the operation log accepting unit 253 accepts the operations performed by the first user, such as the movement of the cursor C, a position of the click operation, and the movement of the scroll bar S. The operation log accepting unit 253 obtains an operation log of the first user on the web page screen P, from the accepted operation. For example, the operation log accepting unit 253 sequentially obtains the operation log of the first user at regular intervals.

The transmission control unit 254 controls the communication unit 230 to transmit log information on the operation obtained by the operation log accepting unit 253, to the server 100. Moreover, the transmission control unit 254 controls the communication unit 230 to transmit the above described attribute information on the first user, which has been inputted by the first user, to the server 100.

### 3. DETAILED CONFIGURATION OF SERVER

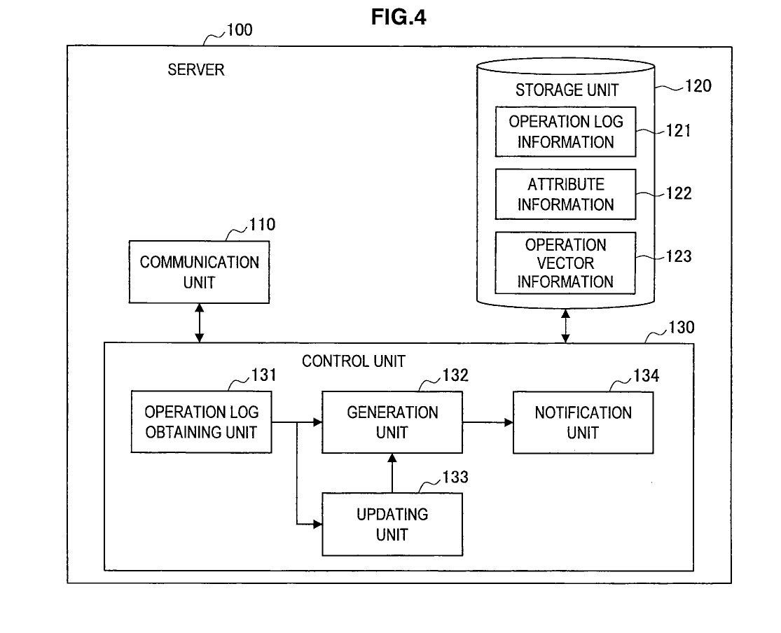

With reference to FIG. 4, the detailed configuration of the server 100 will be described. FIG. 4 is a diagram illustrating the detailed configuration of the server 100. As illustrated in FIG. 4, the server 100 includes a communication unit 110, a storage unit 120 and a control unit 130.

The communication unit 110 has a function of communicating with the first user terminal 200 and the second user terminal 300 based on control by the control unit 130. The communication unit 110, for example, includes a communication device, and may function as a transmission unit and a reception unit.

The storage unit 120 has a function of storing various kinds of information to be used by the control unit 130, and for example, has a function of storing operation log information 121 on the web page screen and attribute information 122 related to the first user, which have been obtained from the first user terminal 200. The storage unit 120, for example, includes a storage device.

The information to be stored by the storage unit 120 will be described herein. For example, information on a movement of a mouse cursor, a position of the scroll bar, the position of the click operation is stored as the operation log information. Moreover, information on a location where the first user terminal 200 has used a GPS function (a location of use by the first user, for example, at home or outside of home) is also stored. Furthermore, access information from the browser of the first user terminal 200, for example, information on UserAgent representing the type of the browser, a URL (IP address) of a web page that is a link source, a form, such as POST or GET, is stored. Furthermore, for example, the information on the user's sex, date of birth, hometown, web environment, frequency of web surfing is stored as the attribute information on the user. These pieces of information are stored with the URL of the web page as index information.

The control unit 130 has a function of controlling all the operations of the server 100, and for example, can control the operations of the server 100 based on information received by the communication unit 110. Note that the control unit 130, for example, includes a CPU, a ROM and a RAM. As illustrated in FIG. 4, the control unit 130 includes an operation log obtaining unit 131 that is an example of a first obtaining unit, a generation unit 132, an updating unit 133 and a notification unit 134.

The operation log obtaining unit 131 obtains log information on an operation performed on one web page screen by a user of another apparatus (for example, the first user terminal 200), via the communication unit 110 from the first user terminal 200. The case where the operation log obtaining unit 131 obtains the operation log information on the first user on the web page P illustrated in FIG. 3, from the first user terminal 200, will be described below. The operation log obtaining unit 131 also obtains the attribute information related to the first user from the first user terminal 200. The operation log obtaining unit 131 outputs the operation log information and the attribute information that have been obtained, to the storage unit 120.

The generation unit 132 generates an operation vector indicating the vector of the operation, based on the operation log information obtained by the operation log obtaining unit 131. The generated operation vector is stored as operation vector information 123 into the storage unit 120. Here, the vector of the operation, for example, indicates a movement of the mouse on the web page. The generation unit 132 calculates the operation vector based on a position of the cursor and a time of the movement of the cursor on the web page.

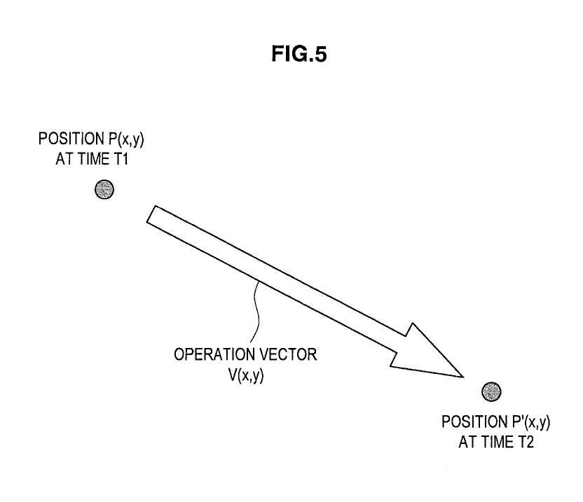

FIG. 5 is a schematic diagram for describing a method of generating the operation vector. It is assumed herein that a mouse cursor positioned at a position P(x,y) at time T1 has moved to a position P′(x,y) at time T2 on the web page, along with the user's operation. Then, an operation vector V(x,y) of the mouse cursor is represented as the following Equation 1.

$$V ( x , y ) = \frac{{P}^{′} ( x , y ) - P ( x , y )}{T 2 - T 1} \qquad ( Equation 1 )$$

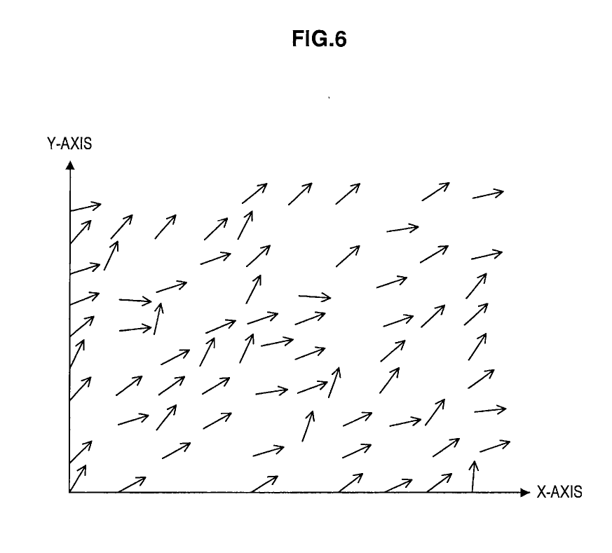

The generation unit 132 generates a plurality of pieces of the operation vector information corresponding to one web page screen. A set of a plurality of operation vectors generated by the generation unit 132 becomes an operation field illustrated in FIG. 6. The operation field indicates the movement of the cursor at each position on one web page. Note that FIG. 6 is a schematic diagram for describing the operation field generated by the generation unit 132.

Returning to FIG. 4, the description will be continued. The generation unit 132 generates the operation vector information (operation field) so as to be associated with an attribute in the attribute information stored in the storage unit 120. In other words, the generation unit 132 generates the operation field for each attribute in the attribute information, for one web page. For example, the generation unit 132 generates the operation field for one web page, based on an operation performed by a user from the same hometown.

The updating unit 133 updates the operation vector (operation field) information. The updating unit 133 determines a frequency of updating the operation field, depending on relevance to the attribute information on the user associated with the operation field. For example, in the case where relevance to attribute information A, B, C, D, N on a user U (A, B and the like correspond to the user's sex, hometown and the like, respectively) is R(U,A), R(U,B), R(U,C), R(U,N), a frequency of updating F(x,y,U,N) while the cursor is positioned at the position P(x,y) is represented as the following Equation 2.

F(x,y,U,N)=k×R(U,N) (Equation 2)

Note that k denotes a constant of the frequency of updating.

The updating unit 133 uses the frequency of updating F(x,y,U,N) to update an operation vector V(x,y,U,N) as in the following Equation 3.

V(x,y,U,N)=V(x,y,U,N)+V′(x,y,U,N)×F(x,y,U,N) (Equation 3)

The updating unit 133 determines the frequency of updating each operation field in a plurality of operation fields associated with one web page. For example, the updating unit 133 sets the frequency of updating the operation vector (operation field) generated so as to be associated with a plurality of attributes, to be higher than the frequency of updating the operation vector (operation field) generated so as to be associated with one attribute. Thereby, the operation field that is associated with the plurality of attributes and has a high frequency of updating can be appropriately updated.

The notification unit 134 notifies the second user terminal 300 that is caused to display one web page screen, of the operation vector (operation field) information generated by the generation unit 132. The notification unit 134, for example, notifies the second user terminal 300 of the operation field information while the second user terminal 300 browses one web page screen.

In the above description, while the server 100 generates the operation vector information depending on the operation log of the first user on one web page, the generation of the operation vector information is not limited thereto. For example, the server 100 may generate the operation vector information depending on operation logs of a plurality of users on one web page.

### 4. DETAILED CONFIGURATION OF SECOND USER TERMINAL

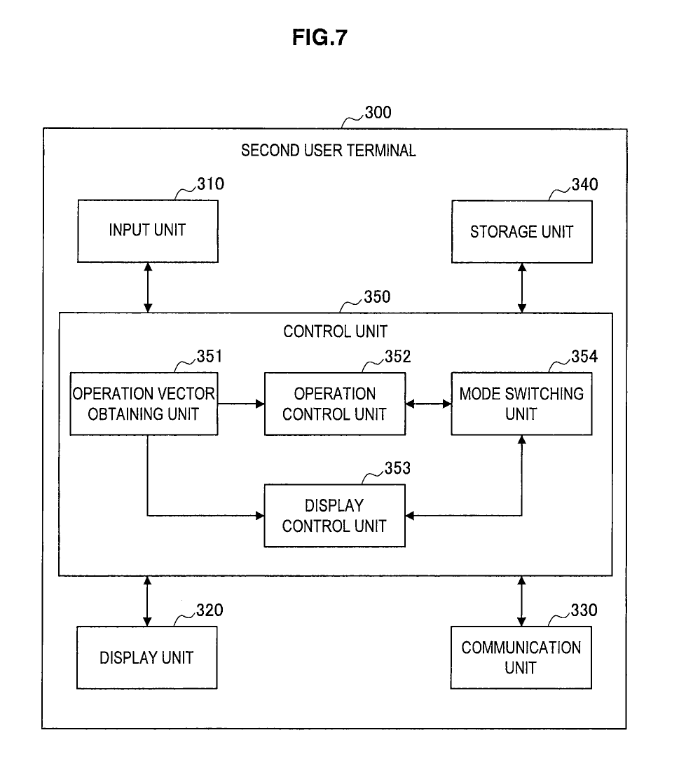

With reference to FIG. 7, the detailed configuration of the second user terminal 300 will be described. FIG. 7 is a diagram illustrating the detailed configuration of the second user terminal 300. As illustrated in FIG. 7, the second user terminal 300 includes an input unit 310, a display unit 320, a communication unit 330, a storage unit 340 and a control unit 350.

The input unit 310 has a function of accepting input of operation information from the second user. The input unit 310 outputs the accepted input of the operation information from the second user, to the control unit 350. The input unit 310, for example, includes an input device, such as a mouse, a keyboard or a touch panel.

The display unit 320 has a function of displaying various kinds of information based on control by the control unit 350. The display unit 320 displays the screen of the web page obtained from the web server. The display unit 320, for example, includes a display device, such as a liquid crystal display.

The communication unit 330 has a function of communicating with the server 100 based on the control by the control unit 350. The communication unit 330, for example, includes a communication device, and may function as a transmission unit and a reception unit. The communication unit 330, for example, receives the web page from the web server.

The storage unit 340 has a function of storing various kinds of information to be used by the control unit 350. The storage unit 340, for example, includes a storage device, such as a magnetic storage device.

The control unit 350 has a function of controlling all the operations of the second user terminal 300, and for example, can control the operations of the second user terminal 300 based on the operation information outputted from the input unit 310, information received by the communication unit 330. The control unit 350, for example, includes a CPU, a ROM and a RAM. As illustrated in FIG. 7, the control unit 350 includes an operation vector obtaining unit 351 that is an example of a second obtaining unit, an operation control unit 352, a display control unit 353, and a mode switching unit 354.

The operation vector obtaining unit 351 obtains the operation vector information related to one web page, via the communication unit 330 from the server 100. The web page P illustrated in FIG. 3 will be described below as one web page, by way of example. The operation vector obtaining unit 351 obtains an operation vector related to the web page P, via the notification unit 134 (FIG. 4) from the server 100.

The operation vector obtaining unit 351 obtains the operation vector information from the server 100 after a predetermined time has elapsed since start of the display of one web page (the web page P) screen on the display unit 320. This can limit a time for obtaining the operation vector information, and can prevent an increase in a processing load on the second user terminal 300.

For example, if there is no operation performed by the second user of the second user terminal 300 until the predetermined time has elapsed, the operation vector obtaining unit 351 obtains the operation vector information from the server 100. If the second user does not perform any operation until the predetermined time has elapsed, it is assumed that the second user is unaccustomed to the operation on the web page P and is at a loss as to how to perform the operation. Accordingly, the operation vector obtaining unit 351 obtains the operation vector information to cause an automatic operation to be performed on the web page. In contrast, if the second user performs the operation before the predetermined time has elapsed, it can be assumed that the second user can search for desired information on the web page P. Accordingly, the operation vector information is not obtained. Thereby, occurrence of any unnecessary process of obtaining the operation vector can be prevented.

The operation control unit 352 controls the operation to be automatically performed on one web page (the web page P) screen displayed on the display unit 320, depending on the operation vector information obtained by the operation vector obtaining unit 351. Thereby, an operation simulating the operation performed on the web page P by the first user is automatically performed without any operation performed by the second user who does not usually browse the web page P. Consequently, information that another user is likely to browse on the web page P can be immediately displayed.

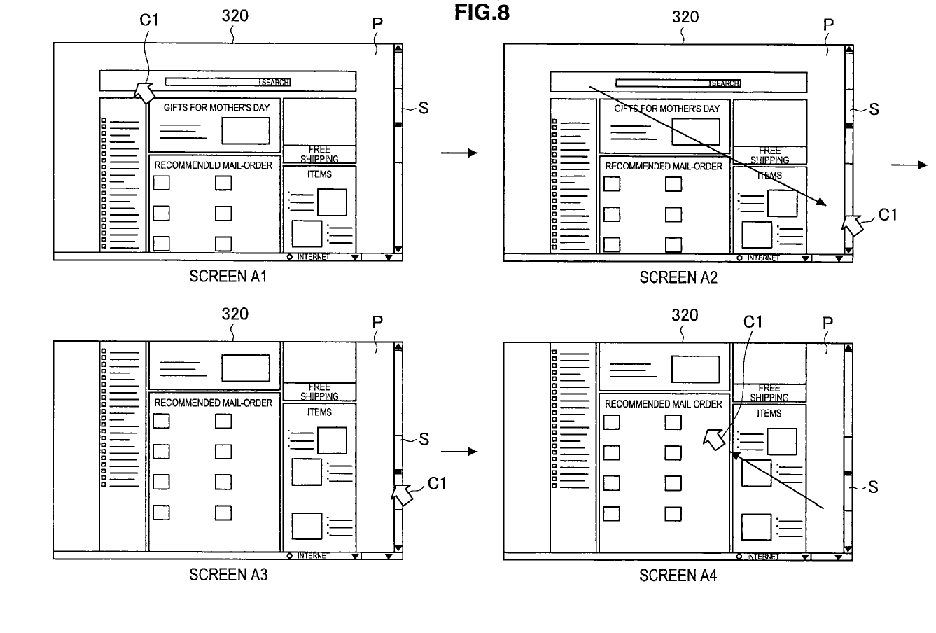

With reference to FIG. 8, a specific example of the automatic operation of the cursor on the web page screen in accordance with the operation control unit 352 will be described. FIG. 8 is a diagram for describing the automatic operation of the cursor on the web page screen.

The operation control unit 352 causes the cursor on one web page screen to automatically move, depending on the operation vector information obtained from the server 100. For example, as illustrated in screens A1 and A2 in FIG. 8, the operation control unit 352 causes a cursor C1 to automatically move in a direction indicated by an arrow on the screen A2.

The operation control unit 352 causes one web page screen to automatically scroll, depending on the operation vector information obtained from the server 100. For example, as illustrated in screens A2 and A3 in FIG. 8, the operation control unit 352 causes the scroll bar S to automatically move with the cursor C1 so as to scroll the web page screen downward.

The operation control unit 352 causes the click operation to be automatically performed on one web page screen, depending on the operation vector information obtained from the server 100. For example, as illustrated in screens A3 and A4 in FIG. 8, the operation control unit 352 stops the movement of the cursor C1, and then performs the click operation on the web page screen. This causes transition to another web page to which a target of the click operation is linked.

Thus, according to the present embodiment, the operation, such as the movement of the cursor C1, is automatically performed depending on the operation vector information obtained from the server 100, without any operation performed on the web page screen by the second user. Accordingly, during browsing the web page P including a large amount of unfamiliar information, the second user can recognize which portion of the web page P may be viewed first. Moreover, the second user can recognize how the first user, who is more accustomed to browsing the web page P than the second user is, has browsed the web page P. In particular, the second user can immediately access a desired web page linked to the web page P.

Returning to FIG. 7, the description will be continued. The display control unit 353 controls the display unit 320 to display the obtained web page in the web browser. Moreover, the display control unit 353 switches the display of the cursor depending on the automatic operation caused by the operation control unit 352.

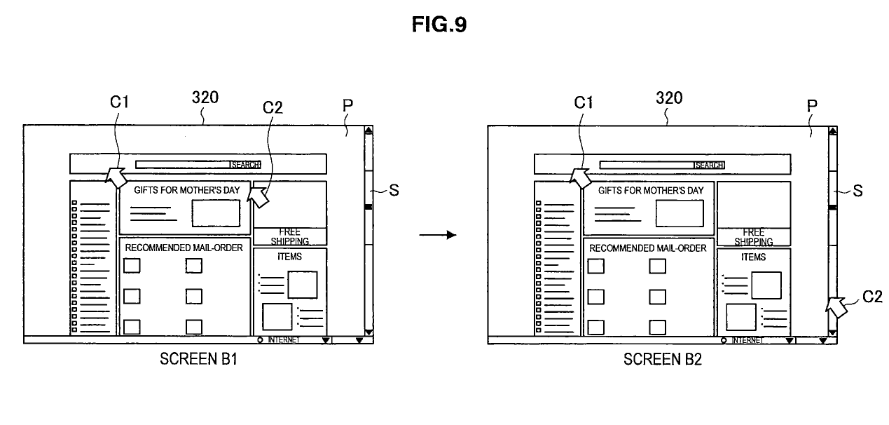

As illustrated in FIG. 9, the display control unit 353 controls a pseudo-cursor C2 different from the cursor C1 for the operation, to be displayed such that the pseudo-cursor C2 moves on one web page screen, depending on the operation vector information obtained by the operation vector obtaining unit 351. The second user can see the pseudo-cursor C2 moving in the display, and thereby recognize how to browse the desired information on the web page P, before the second user operates the cursor C1 for the operation. Then, the second user can search for the desired information by simulating the movement of the pseudo-cursor C2 to operate the cursor C1 for the operation.

FIG. 9 is a diagram for describing the displayed movement of the pseudo-cursor C2. As illustrated in screens B1 and B2 in FIG. 9, the pseudo-cursor C2 is moving toward the scroll bar S. The second user can scroll the web page screen by simulating the movement of the pseudo-cursor C2 to move the cursor C1 for the operation onto the scroll bar S and move the scroll bar S.

As illustrated in FIG. 9, the display control unit 353 causes both the cursor C1 for the operation and the pseudo-cursor C2 to be displayed on one web page screen. Here, a display color of the pseudo-cursor C2 is different from a display color of the cursor C1 for the operation. Specifically, the display color of the pseudo-cursor C2 is a color lighter than the display color of the cursor C1 for the operation. Hence, the user can easily identify the pseudo-cursor C2. Note that while the pseudo-cursor C2 has the display color different from that of the cursor C1 for the operation as described above, the difference is not limited thereto. For example, a pattern of the pseudo-cursor C2 may be different from a pattern of the cursor C1 for the operation.

The mode switching unit 354 performs switching between two modes (a first mode and a second mode) related to the operation on the web page screen. Here, the first mode is a mode for the operation control unit 352 to control the operation to be automatically performed on one web page screen, depending on the operation vector information. The second mode is a mode for the display control unit 353 to control the pseudo-cursor to be displayed such that the pseudo-cursor moves on one web page screen, depending on the operation vector information. Note that the second user can previously set the switching between the modes. Thus, in the case where the switching between the two modes is performed, the mode (the mode for automatically performing the operation, or the mode for displaying the pseudo-cursor C2) can be set depending on the second user's preference, and thereby a user-friendly user terminal (information processing apparatus) can be realized.

### 5. OPERATIONS OF INFORMATION PROCESSING SYSTEM

Next, an operation example of the information processing system 10 will be described. A process of generating the operation field by the server 100, and an automatic operation process performed on the web page screen by the second user terminal 300 will be described below in this order.

(5-1. Process of Generating Operation Field)

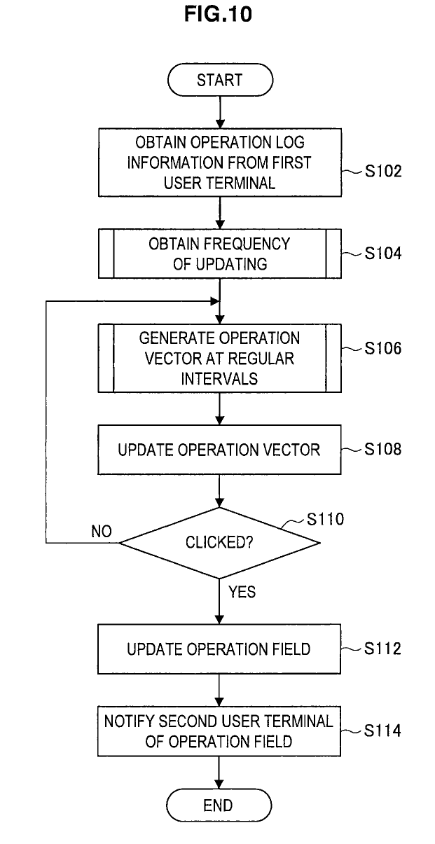

With reference to FIG. 10, the process of generating the operation field by the server 100 will be described. FIG. 10 is a flowchart illustrating the process of generating the operation field by the server 100.

This process is realized by executing a program stored in the ROM, by the CPU of the control unit 130 in the server 100. Moreover, the flowchart of FIG. 10 begins with the first user of the first user terminal 200 performing the operation on one web page (here, the web page P in FIG. 3) displayed on the display unit 220.

The operation log obtaining unit 131 of the control unit 130 first obtains the log information on the operation performed on one web page (the web page P) screen by the first user (such as the movement of the cursor), from the first user terminal 200 (step S102). Next, the updating unit 133 obtains the frequency of updating the operation vector (step S104).

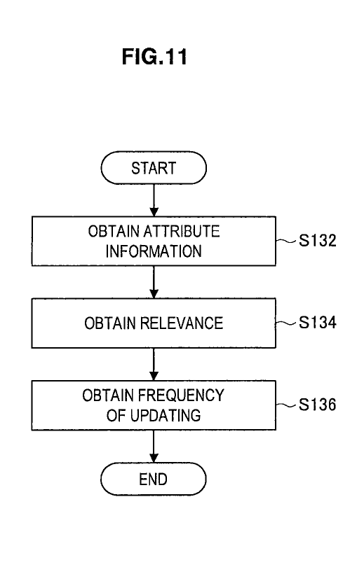

FIG. 11 is a flowchart illustrating a process of obtaining the frequency of updating the operation field. The updating unit 133 first obtains the attribute information on the first user (such as the first user's hometown) (step S132). Note that the attribute information on the first user is previously stored in the storage unit 120.

Next, the updating unit 133 obtains the relevance R(U,N) between the obtained attribute information and the web page P (step S134). Then, the updating unit 133 obtains the frequency F(x,y,U,N) of updating the operation field (operation vector), based on the obtained relevance (step S136). Thereby, the process of obtaining the frequency of updating in step S104 ends.

Returning to FIG. 10, the description of the process of generating the operation field will be continued. If the frequency of updating is obtained in step S104, the generation unit 132 generates the operation vector of the cursor at regular intervals (step S106).

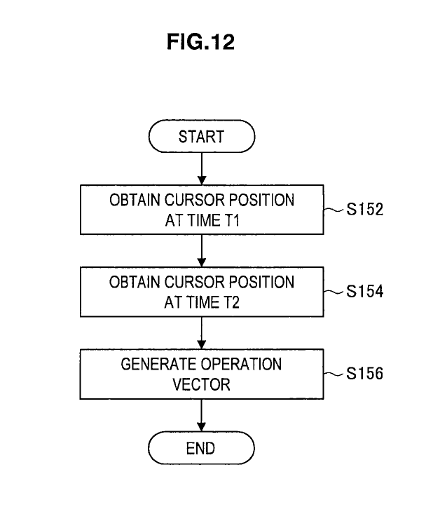

FIG. 12 is a flowchart illustrating a process of generating the operation vector of the cursor. The generation unit 132 first obtains the position P(x,y) of the cursor on the web page P at time T1 (step S152). The generation unit 132 next obtains the position P′(x,y) of the cursor at time T2 (step S154). Then, as illustrated in FIG. 5 described above, the generation unit 132 generates the operation vector V(x,y) based on the position P(x,y) and the position P′(x,y) (step S156). Thereby, the process of generating the operation vector in step S106 ends.

Returning to FIG. 10, the description of the process of generating the operation field will be continued. The updating unit 133 uses the frequency of updating F obtained in step S104, to update the operation vector V of the cursor at each position on the web page (step S108).

Next, the control unit 130 determines whether or not the click operation on the cursor has been performed (step S110). If it is determined in step S110 that the click operation has not been performed (No), it is assumed that the first user is operating the cursor to move. Accordingly, the control unit 130 repeats the above processes in steps S106 and S108.

In contrast, if it is determined in step S110 that the click operation has been performed (Yes), for example, it is assumed that the transition to the linked web page has been performed. Accordingly, the updating unit 133 updates the operation field (a set of the movements of the cursor) (step S112). Next, the notification unit 134 notifies the second user terminal 300 of the updated operation field (step S114). Thereby, this process is completed.

According to this process, the server 100 obtains the log information on the operation performed on one web page screen by the first user of the first user terminal 200, from the first user terminal 200, and generates the operation vector information indicating the vector of the operation, based on the obtained operation log information. Then, the server 100 notifies another apparatus (the second user terminal 300) that is caused to display one web page screen, of the generated operation vector information. Thereby, even if the second user of the second user terminal is unaccustomed to the operation on one web page, the operation is performed depending on the operation vector information of which the second user terminal has been notified. Accordingly, the second user of the second user terminal can easily search for the desired information on one web page.

(5-2. Automatic Operation Process on Web Page Screen)

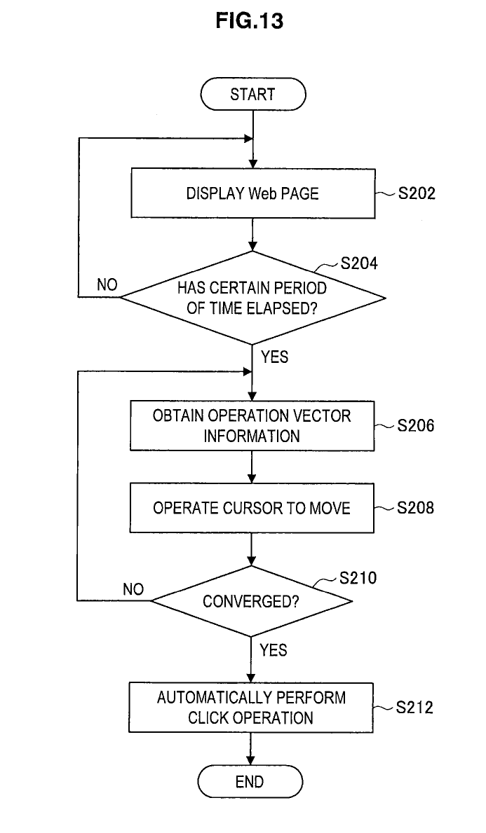

With reference to FIG. 13, the automatic operation process performed on the web page screen by the second user terminal 300 will be described. FIG. 13 is a flowchart illustrating the automatic operation process performed on the web page screen by the second user terminal 300.

This process is realized by executing a program stored in the ROM, by the CPU of the control unit 350 in the second user terminal 300. Moreover, the flowchart of FIG. 13 begins with the second user of the second user terminal 300 performing an operation of displaying one web page (here, the web page P in FIG. 3) on the display unit 320.

The display control unit 353 of the control unit 350 first displays one web page (the web page P) on the display unit 320 (step S202). Next, the control unit 350 determines whether or not a certain period of time has elapsed since the display of the web page P (step S204).

If it is determined in step S204 that the certain period of time has elapsed (Yes), it is assumed that the second user is at a loss as to how to perform the operation on the web page P. Accordingly, the operation vector obtaining unit 351 obtains the operation vector information (step S206).

Next, as illustrated in FIG. 8 described above, the operation control unit 352 performs an operation of causing the cursor to move on the web page P, depending on the obtained operation vector information (step S208). In other words, the operation control unit 352 causes the cursor to automatically move on the web page P, in a manner simulating the operation performed on the web page by the first user, without any cursor operation performed by the second user.

Next, the control unit 350 determines whether or not the obtained operation vectors have converged (step S210). If it is determined in step S210 that the operation vectors have not converged (No), it is assumed that the first user has further moved the cursor on the web page. Accordingly, processes in steps S206 and S208 are repeated.

If it is determined in step S210 that the operation vectors have converged (Yes), it is assumed that the click is performed on the web page. Accordingly, the operation control unit 352 performs the click operation (step S212). Thereby, for example, screen transition from the web page P to another linked web page is automatically performed.

According to this process, for example, if the second user accesses a web page (top page) related to taxes, which the second user does not usually use, for year-end adjustment, an operation of moving the cursor is automatically performed in a manner simulating an operation performed on the web page by another user, and transition from the top page to a page related to the year-end adjustment is automatically performed. Accordingly, on the top page, even if the second user does not know information related to a linked page, the automatic transition to the page related to the year-end adjustment improves operability on the web page.

### 6. CONCLUSION

According to the present embodiment, the second user terminal 300 obtains the operation vector information that is generated based on the log information on the operation performed on one web page screen by the first user of the first user terminal, and that indicates the vector of the operation, from the server. Then, the second user terminal 300 controls an operation to be automatically performed on one web page screen displayed on the display unit 320, depending on the obtained operation vector information.

Accordingly, the second user can easily browse desired information from the web page, and even from a web page that the second user does not usually browse. In other words, as illustrated in FIG. 8, the automatic movement of the cursor depending on the operation field means that transition of one web page followed by the first user is automatically performed. Hence, if the second user browses one web page unfamiliar to the second user or one web page including a huge amount of information, the second user can immediately search for information that another user is likely to browse. Moreover, the second user can be assisted in recognizing which portion of one web page displayed on the display unit 320 may be viewed first, and furthermore, web surfing can also be automatically performed.

While the preferred embodiments of the present disclosure have been described above in detail with reference to the appended drawings, the technical scope of the present disclosure is not limited to such examples. It is obvious that various alteration examples or modification examples may be conceived by those skilled in the art of the present disclosure, insofar as such alteration examples or modification examples are within the category of the technical idea described in the claims. It is understood that such alteration examples or modification examples also naturally belong to the technical scope of the present disclosure.

While the operation log information on the first user terminal has been described above with the mouse operation performed by the first user, by way of example, the operation log information is not limited thereto. For example, the operation log information may be information on a touch operation performed on the touch panel by the first user. Moreover, the operation log information may be information on detection of the first user's eye-gaze movement with respect to the web page.

Moreover, while the configurations of the control units of the first user terminal 200 and the second user terminal 300 are different in the above description, the configurations thereof are not limited thereto. For example, the first user terminal and the second user terminal may include both the configurations of the control units illustrated in FIGS. 2 and 7.

Moreover, while the first user terminal and the second user terminal include the display units in the above description, the display units are not limited thereto, and may be provided in external devices outside the user terminals. In such a case, the user terminals control display on the display units in the external devices.

Moreover, the steps illustrated in the flowcharts of the above described embodiments naturally include processes to be performed in time series in order as described above, and also include processes that are not necessarily processed in time series but are executed in parallel or individually. In addition, needless to say, even the order of the steps to be processed in time series may be changed as appropriate in some cases.

Additionally, the present disclosure may also be configured as below.

(1)

An information processing apparatus, including:

an obtaining unit that obtains operation vector information that is generated based on log information on an operation performed on one web page screen by a user of another apparatus, and that indicates a vector of the operation, from a server; and

an operation control unit that controls an operation to be automatically performed on the one web page screen displayed on a display unit, depending on the operation vector information obtained by the obtaining unit.

(2)

The information processing apparatus according to (1), wherein:

the operation control unit causes a cursor on the one web page screen to automatically move, depending on the operation vector information.

(3)

The information processing apparatus according to (1) or (2), wherein:

the operation control unit causes the one web page screen to automatically scroll, depending on the operation vector information.

(4)

The information processing apparatus according to any one of (1) to (3), wherein:

the operation control unit causes a click operation to be automatically performed on the one web page screen, depending on the operation vector information.

(5)

The information processing apparatus any one of (1) to (4), wherein:

the obtaining unit obtains the operation vector information from the server after a predetermined time has elapsed since start of the display of the one web page screen on the display unit.

(6)

The information processing apparatus according to (5), wherein:

the obtaining unit obtains the operation vector information from the server if a user of the information processing apparatus does not perform any operation until the predetermined time has elapsed.

(7)

The information processing apparatus according to any one of (1) to (6), further including:

a display control unit that controls a pseudo-cursor different from a cursor for the operation, to be displayed such that the pseudo-cursor moves on the one web page screen, depending on the operation vector information obtained by the obtaining unit.

(8)

The information processing apparatus according to (7), wherein:

a display color of the pseudo-cursor is different from a display color of the cursor for the operation, and

the display control unit causes both the cursor for the operation and the pseudo-cursor to be displayed on the one web page screen.

(9)

The information processing apparatus according to (7) or (8), further including:

a mode switching unit that performs switching between
a first mode for the operation control unit to control the operation to be automatically performed on the one web page screen, depending on the operation vector information; and
a second mode for the display control unit to control the pseudo-cursor to be displayed such that the pseudo-cursor moves on the one web page screen, depending on the operation vector information.
   (10)

An information processing method, including:

obtaining operation vector information that is generated based on log information on an operation performed on one web page screen by a user of another apparatus, and that indicates a vector of the operation, from a server; and

controlling an operation to be automatically performed on the one web page screen displayed on a display unit, depending on the obtained operation vector information.

(11)

A program that causes a computer to execute:

obtaining operation vector information that is generated based on log information on an operation performed on one web page screen by a user of another apparatus, and that indicates a vector of the operation, from a server; and

controlling an operation to be automatically performed on the one web page screen displayed on a display unit, depending on the obtained operation vector information.

(12)

A server including:

an obtaining unit that obtains log information on an operation performed on one web page screen by a user of one apparatus, from the one apparatus;

a generation unit that generates operation vector information indicating a vector of the operation, based on the operation log information obtained by the obtaining unit; and

a notification unit that notifies another apparatus that is caused to display the one web page screen, of the operation vector information generated by the generation unit.

(13)

The server according to (12), wherein:

the generation unit generates a plurality of pieces of the operation vector information corresponding to the one web page screen.

(14)

The server according to (13), further including:

a storage unit that stores attribute information on the user,

wherein the generation unit generates the operation vector information so as to be associated with an attribute in the attribute information stored in the storage unit.

(15)

The server according to (14), further including:

an updating unit that updates the operation vector information,

wherein the updating unit sets a frequency of updating the operation vector information generated so as to be associated with a plurality of the attributes, to be higher than a frequency of updating the operation vector information generated so as to be associated with one of the attributes.

(16)

An information processing method, including:

obtaining log information on an operation performed on one web page screen by a user of one apparatus, from the one apparatus;

generating operation vector information indicating a vector of the operation, based on the obtained operation log information; and

notifying another apparatus that is caused to display the one web page screen, of the generated operation vector information.

(17)

A program that causes a computer to execute:

obtaining log information on an operation performed on one web page screen by a user of one apparatus, from the one apparatus;

generating operation vector information indicating a vector of the operation, based on the obtained operation log information; and

notifying another apparatus that is caused to display the one web page screen, of the generated operation vector information.

(18)

An information processing system, including:

an information processing apparatus; and

a server communicable with the information processing apparatus and another apparatus,

wherein the server includes
a first obtaining unit that obtains log information on an operation performed on one web page screen by a user of the other apparatus, from the other apparatus;
a generation unit that generates operation vector information indicating a vector of the operation, based on the operation log information obtained by the first obtaining unit; and
a notification unit that notifies the information processing apparatus that is caused to display the one web page screen, of the operation vector information generated by the generation unit, and

wherein the information processing apparatus includes
a second obtaining unit that obtains the operation vector information generated by the generation unit, via the notification unit from the server; and
an operation control unit that controls an operation to be automatically performed on the one web page screen displayed on a display unit, depending on the operation vector information obtained by the second obtaining unit.

The present disclosure contains subject matter related to that disclosed in Japanese Priority Patent Application JP 2011-112343 filed in the Japan Patent Office on May 19, 2011, the entire content of which is hereby incorporated by reference.

What is claimed is:

1. An information processing apparatus, comprising:
an obtaining unit that obtains operation vector information that is generated based on log information on an operation performed on one web page screen by a user of another apparatus, and that indicates a vector of the operation, from a server; and
an operation control unit that controls an operation to be automatically performed on the one web page screen displayed on a display unit, depending on the operation vector information obtained by the obtaining unit.

2. The information processing apparatus according to claim 1, wherein:
the operation control unit causes a cursor on the one web page screen to automatically move, depending on the operation vector information.

3. The information processing apparatus according to claim 1, wherein:
the operation control unit causes the one web page screen to automatically scroll, depending on the operation vector information.

4. The information processing apparatus according to claim 1, wherein:
the operation control unit causes a click operation to be automatically performed on the one web page screen, depending on the operation vector information.

5. The information processing apparatus according to claim 1, wherein:
the obtaining unit obtains the operation vector information from the server after a predetermined time has elapsed since start of the display of the one web page screen on the display unit.

6. The information processing apparatus according to claim 5, wherein:
the obtaining unit obtains the operation vector information from the server if a user of the information processing apparatus does not perform any operation until the predetermined time has elapsed.

7. The information processing apparatus according to claim 1, further comprising:
a display control unit that controls a pseudo-cursor different from a cursor for the operation, to be displayed such that the pseudo-cursor moves on the one web page screen, depending on the operation vector information obtained by the obtaining unit.

8. The information processing apparatus according to claim 7, wherein:
a display color of the pseudo-cursor is different from a display color of the cursor for the operation, and
the display control unit causes both the cursor for the operation and the pseudo-cursor to be displayed on the one web page screen.

9. The information processing apparatus according to claim 7, further comprising:
a mode switching unit that performs switching between
a first mode for the operation control unit to control the operation to be automatically performed on the one web page screen, depending on the operation vector information; and
a second mode for the display control unit to control the pseudo-cursor to be displayed such that the pseudo-cursor moves on the one web page screen, depending on the operation vector information.

10. An information processing method, comprising:
obtaining operation vector information that is generated based on log information on an operation performed on one web page screen by a user of another apparatus, and that indicates a vector of the operation, from a server; and
controlling an operation to be automatically performed on the one web page screen displayed on a display unit, depending on the obtained operation vector information.

11. A program that causes a computer to execute:
obtaining operation vector information that is generated based on log information on an operation performed on one web page screen by a user of another apparatus, and that indicates a vector of the operation, from a server; and
controlling an operation to be automatically performed on the one web page screen displayed on a display unit, depending on the obtained operation vector information.

12. A server comprising:
an obtaining unit that obtains log information on an operation performed on one web page screen by a user of one apparatus, from the one apparatus;
a generation unit that generates operation vector information indicating a vector of the operation, based on the operation log information obtained by the obtaining unit; and
a notification unit that notifies another apparatus that is caused to display the one web page screen, of the operation vector information generated by the generation unit.

13. The server according to claim 12, wherein:
the generation unit generates a plurality of pieces of the operation vector information corresponding to the one web page screen.

14. The server according to claim 13, further comprising:
a storage unit that stores attribute information on the user,
wherein the generation unit generates the operation vector information so as to be associated with an attribute in the attribute information stored in the storage unit.

15. The server according to claim 14, further comprising:
an updating unit that updates the operation vector information,
wherein the updating unit sets a frequency of updating the operation vector information generated so as to be associated with a plurality of the attributes, to be higher than a frequency of updating the operation vector information generated so as to be associated with one of the attributes.

16. An information processing method, comprising:
obtaining log information on an operation performed on one web page screen by a user of one apparatus, from the one apparatus;
generating operation vector information indicating a vector of the operation, based on the obtained operation log information; and
notifying another apparatus that is caused to display the one web page screen, of the generated operation vector information.

17. A program that causes a computer to execute:
obtaining log information on an operation performed on one web page screen by a user of one apparatus, from the one apparatus;
generating operation vector information indicating a vector of the operation, based on the obtained operation log information; and
notifying another apparatus that is caused to display the one web page screen, of the generated operation vector information.

18. An information processing system, comprising:
an information processing apparatus; and
a server communicable with the information processing apparatus and another apparatus,
wherein the server includes
a first obtaining unit that obtains log information on an operation performed on one web page screen by a user of the other apparatus, from the other apparatus;
a generation unit that generates operation vector information indicating a vector of the operation, based on the operation log information obtained by the first obtaining unit; and
a notification unit that notifies the information processing apparatus that is caused to display the one web page screen, of the operation vector information generated by the generation unit, and
wherein the information processing apparatus includes
a second obtaining unit that obtains the operation vector information generated by the generation unit, via the notification unit from the server; and
an operation control unit that controls an operation to be automatically performed on the one web page screen displayed on a display unit, depending on the operation vector information obtained by the second obtaining unit.
